(19) United States
(12) Patent Application Publication
(10) Pub. No.: US 2025/0284056 A1
(43) Pub. Date: Sep. 11, 2025

(54) DEVICES AND METHODS FOR POLARIZATION CONTROL AND WAVELENGTH MULTIPLEXING

(71) Applicant: New York University in Abu Dhabi Corporation, Abu Dhabi (AE)

(72) Inventors: Zakriya Mohammed, Abu Dhabi (AE); Bruna Paredes, Abu Dhabi (AE); Mahmoud Raras, Abu Dhabi (AE)

(21) Appl. No.: 18/857,308

(22) PCT Filed: Apr. 18, 2023
(86) PCT No.: PCT/IB2023/000250

§ 371 Date: Oct. 16, 2024

Related U.S. Application Data
(60) Provisional application No. 63/332,532, filed on Apr. 19, 2022.

(51) Int. Cl. G02B 6/126; G02B 6/12; G02B 6/122; G02B 6/125

(52) U.S. Cl. CPC G02B 6/126; G02B 6/1228; G02B 6/125; G02B 2006/12119; G02B 2006/12164

(57) ABSTRACT

A system for a waveguide-based diplexer (wavelength multiplexer/demultiplexer) and polarizer having ultra-broad bandwidth, a compact footprint, low losses, fabrication robustness and a simple single etch fabrication process. The polarizer (TE-pass) is based on the phase-matched coupling of the unwanted TM0 mode in an input waveguide to the TM1 mode in a tapered directional coupler (DC), which is then guided through a low-loss bend (180-degree) and scattered in a terminator section with low back reflections. An S-bend is added before the output for filtering any residual TM0mode present in the input waveguide. The diplexer is based on a multimode interference (MMI) coupler and is designed at the first imaging length for 1550 nm wavelength resulting in a compact MMI length. In order to improve the extinction ratio, the output ports are made asymmetric in width.

### CROSS-REFERENCE TO RELATED APPLICATIONS

This application claims priority to U.S. provisional application No. 63/332,532 filed on Apr. 19, 2022, incorporated herein by reference in its entirety.

### BACKGROUND OF THE INVENTION

In recent years, on-chip silicon photonics has drawn interest for its high density, low power consumption and great compatibility with the mature compatibility with complementary metal-oxide-semiconductor (CMOS) fabrication techniques. However, polarization dispersion is strong due to the high index contrast in the silicon waveguides. Hence, it is quite difficult to eliminate the polarization dependence of silicon photonic integrated devices. Thus, polarization-diversity technology is extremely important for on-chip silicon photonics. A polarizer is a key building block in facilitating the polarization diversity technology.

A diplexer is a passive device that implements frequency-domain multiplexing. The wavelength demultiplexers play very important roles in optical transmission systems using wavelength division multiplexing (WDM) technology, which can increase the number of channels and the information capacity of optical fibers.

### SUMMARY OF THE INVENTION

In one aspect, the present invention relates to a transverse-electric (TE) polarizer, comprising: a tapered multimode waveguide; a 180-degree bend following the multimode waveguide; a linear terminator following the 180-degree bend; and a termination of input waveguide with an S-Bend.

In one embodiment, the TE polarizer comprises a multimode waveguide that is tapered and brought close to a single mode waveguide with a uniform gap, forming an asymmetrical directional coupler (ADC).

In an additional embodiment, the TE polarizer comprises a CMOS compatible design comprising of an etch strip waveguide.

In one aspect, the present invention relates to a multi-mode interface (MMI) coupler diplexer, comprising: an MMI length equal to the first beat length for the respective waveguide width; asymmetric output port widths; output tapers with asymmetric starting widths and symmetric end widths; output channels with S-Bends.

In one embodiment, the MMI Coupler comprises one output channel as a bar-port and the other output channel as a cross-port.

In another embodiment, the MMI Coupler comprises a CMOS compatible design.

In another embodiment, the MMI Coupler comprises a single etch strip waveguide.

In another embodiment, the MMI Coupler comprises no subwavelength grating structures.

In another embodiment, the MMI Coupler comprises a first imaging length of 1550 nm.

In another embodiment, the MMI Coupler comprises a design that can demultiplex both 1310 nm and 1550 nm light.

In another aspect, an optical polarizer comprises a substrate; an input waveguide positioned on the substrate having an input end and an output end, and a channel running from the input end to the output end; a tapered multimode waveguide positioned on the substrate having at least one side substantially parallel to at least a portion of the channel and positioned at a distance from the at least a portion of the channel, having an input end and an output end; a terminator positioned on the substrate connected to the output end of the tapered multimode waveguide; and an s-bend positioned on the substrate along the channel of the input waveguide.

In one embodiment, the polarizer further comprises a bend positioned on the substrate connecting the output of the tapered multimode waveguide to the terminator.

In one embodiment, the bend is a 180-degree bend.

In one embodiment, the multimode waveguide is tapered and proximate to a single mode waveguide with a uniform gap forming an asymmetrical directional coupler (ADC).

In one embodiment, the design is complementary metal-oxide semiconductor (CMOS) compatible.

In one embodiment, the substrate comprises SiO₂ and the input waveguide and tapered multimode waveguide comprise silicon (Si) or silicon nitride (SiN).

In one embodiment, the terminator is tapered with its ending width tending to zero.

In another aspect, an optical demultiplexer comprises a substrate; an input channel positioned on the substrate having an input end and an output end, defining a primary axis running from the input end to the output end, the input channel configured to receive at least two multiplexed optical signals having different wavelengths; a multimode interface (MMI) coupler positioned on the substrate and connected to the output end of the input channel, the MMI coupler having a length running parallel to the primary axis and a width perpendicular to the primary axis; and at least two output channels positioned on the substrate at the opposite end of the MMI coupler from the input channel, each configured to receive one of the at least two multiplexed optical signals; wherein the length of the MMI coupler is about equal to a first beat length of one of the wavelengths of the at least two multiplexed optical signals.

In one embodiment, one of the output channels terminates in a bar-port and the other output channel terminates in a cross-port, and wherein the bar and cross port widths are asymmetric.

In one embodiment, at least one of the at least two output channels comprises an S-bend.

In one embodiment, the input channel comprises a tapered portion, wherein the starting width of the taper is narrower, and the ending width is wider connecting the MMI coupler.

In one embodiment, at least one of the at least two output channels comprises a tapered portion, wherein the output tapers have asymmetric starting widths, and symmetric end widths connecting S-bends.

In one embodiment, the MMI coupler is substantially rectangular.

In one embodiment, the optical demultiplexer is fully CMOS compatible.

In one embodiment, the substrate comprises SiO₂ and the input channel, MMI coupler, and output channels comprise silicon (Si) or silicon nitride (SiN).

In one embodiment, one wavelength of the wavelengths of the at least two multiplexed optical signals is 1550 nm.

In one embodiment, the length of the MMI coupler is about 41 μm.

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements, and in which:

FIG. 1A depicts a perspective view diagram of a TE-pass polarizer.

FIG. 1B depicts a cross-section of a silicon waveguide (single-etch) for the TE-pass polarizer of FIG. 1A.

FIG. 1C depicts a top view diagram of the TE-pass polarizer of FIG. 1A.

FIG. 2A is a diagram of calculated effective refractive indices (n_{eff}) of eigen modes vs. waveguide width for a 220 nm thick silicon waveguide.

FIG. 2B is a diagram of bending loss as a function of radius R.

FIG. 2C is a diagram of reflectance vs terminator length Lₜ.

FIG. 3A depicts a beam propagation profiles with TE0 input.

FIG. 3B depicts a beam propagation profiles with TM0 input.

FIG. 3C is a diagram of normalized transmission spectra for TE and TM polarizations.

FIG. 4 depicts a simulated transmission for TE and TM polarization input as a function of width variation.

FIG. 5A depicts a beam profile of cascaded design with TE0 input (1550 nm).

FIG. 5B depicts a beam profile of cascaded design with TM0 input (1550 nm).

FIG. 5C is a diagram of the normalized transmission spectra for the cascaded structure.

FIG. 6 depicts SEM images of the fabricated TE-pass polarizers.

FIG. 7A depicts measured normalized transmission spectra of the TE-pass polarizer (1-stage).

FIG. 7B depicts measured normalized transmission spectra of the TE-pass polarizer (2-stage).

FIG. 8A depicts a perspective view diagram of a diplexer.

FIG. 8B depicts a top view diagram of the diplexer of FIG. 8A.

FIG. 9A is a diagram of beat length vs Silicon waveguide width for a silicon thickness of 220 nm.

FIG. 9B depicts a cross-section of silicon waveguide (single-etch).

FIG. 10 depicts a simulated extinction ratio of device as a function of MMI width.

FIG. 11A depicts a simulated Extinction ratio of the device as a function of cross port width.

FIG. 11B depicts a simulated transmission of the device as a function of cross port width

FIG. 12A depicts a simulated field evolution at 1550/1310 nm wavelengths without higher order mode filtering.

FIG. 12B depicts a simulated field evolution at 1550/1310 nm wavelengths after optimization with mode filter design.

FIG. 13A depicts power transmission at Bar and Cross ports for O-band light.

FIG. 13B depicts power transmission at Bar and Cross ports for C-band light.

FIG. 14 depicts SEM images of the fabricated diplexer.

FIG. 15A depicts measured transmission at the output ports for 1310 nm band.

FIG. 15B depicts measured transmission at the output ports for 1550 nm band.

FIG. 16 depicts an experimental setup for on-chip wavelength division demultiplexing.

FIG. 17A depicts a measured eye-diagram of the pre amplified optical signal 1550 nm.

FIG. 17B depicts a measured eye-diagram of the pre amplified optical signal 1310 nm.

FIG. 17C depicts a measured eye-diagram of multiplexed optical signal.

FIG. 17D depicts a measured eye-diagram of the demultiplexed signal at cross-port (1550 nm).

FIG. 17E depicts a measured eye-diagram of the demultiplexed signal at bar-port (1310 nm).

### DETAILED DESCRIPTION

Silicon Photonics on silicon-on-insulator (SOI) technology is a promising platform for integrating compact optical devices and circuits, driven by its compatibility with complementary metal-oxide-semiconductor (CMOS) processes. The large refractive index contrast on the SOI platform allows sharp bends and hence compact devices by strong optical confinement. However, due to high index contrast polarization dispersion is very strong in silicon waveguides. In most planar waveguide cross-sections, the transverse electric (TE) and transverse magnetic (TM) modes have different confinement factors, mode profiles, effective and group indices. Due to this reason, silicon photonics devices and circuits are optimized for operation with one of the two polarizations (if TE). Any unwanted fraction of the cross-polarization (then TM) may cause performance degradation and should ideally be blocked.

It is to be understood that the figures and descriptions of the present invention have been simplified to illustrate elements that are relevant for a clear understanding of the present invention, while eliminating, for the purpose of clarity, many other elements found in related systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, exemplary methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of +20%, +10%, +5%, +1%, and +0.1% from the specified value, as such variations are appropriate.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, 6 and any whole and partial increments therebetween. This applies regardless of the breadth of the range.

### Compact and Broadband Silicon TE-Pass Polarizer Based on Tapered Directional Coupler

The cross-polarization can be introduced into the silicon chip while coupling from optical fiber when polarization is not well controlled. The polarization control is not an issue when fiber-to-chip grating couplers are used since the gratings themselves act as polarizers. However, with fiber-to-chip edge couplers, efficient external polarization control is necessary. The edge couplers based on inverse tapers will couple both TE and TM polarization states present in the fiber into the silicon waveguide. The undesired polarization can also result from an imperfect operation of other on-chip components, such as polarization beam splitters and polarization splitter and rotators. In both cases, on-chip polarizers can be used to remove any unwanted polarization components, thus reducing polarization crosstalk.

Various types of on-chip SOI based TM-pass or TE-pass polarizers have been realized, including the ones utilizing subwavelength grating (SWG) waveguides, silicon hybrid plasmonic waveguides, graphene structures, photonic crystals, and asymmetric directional couplers (ADC). However, the fabrication process for deep subwavelength gratings is quite complex, and due to scattering in the gratings, the insertion loss (IL) is very high. Polarizers based on plasmonic waveguides can achieve high extinction ratios (ER) in a small footprint, but they require very specific metals, and insertion loss (IL) is still significant. Photonic crystal-based polarizers usually transmit the selected polarization state with relatively high insertion loss, and their fabrication is challenging. Though the fabrication of ADC-based polarizers is simple, it has limited bandwidth (˜30 nm) due to the wavelength sensitivity of conventional directional coupler (DC). Furthermore, any fabrication error introduces phase mismatching, resulting in the designed coupling wavelength deviation.

In one aspect, the present disclosure provides a TE-pass polarizer using the concept of a tapered DC. In certain embodiments, the disclosed polarizer has ultra-broad bandwidth, compact footprint, low losses, and fabrication robustness with a simple single etch fabrication process. A tapered DC is an efficient design to relax fabrication tolerance and bandwidth limitations of conventional DCs in devices such as polarization splitters and rotators, mode multiplexers, and 3 dB couplers.

In some embodiments the disclosed device is an on-chip polarizer and is widely in demand for polarization control in optical communication systems. Therefore, some embodiments disclosed herein may be used in fiber-optic communication. Some embodiments disclosed herein may comprise a CMOS compatible design which allows for use in optical interconnects, for example in data centers.

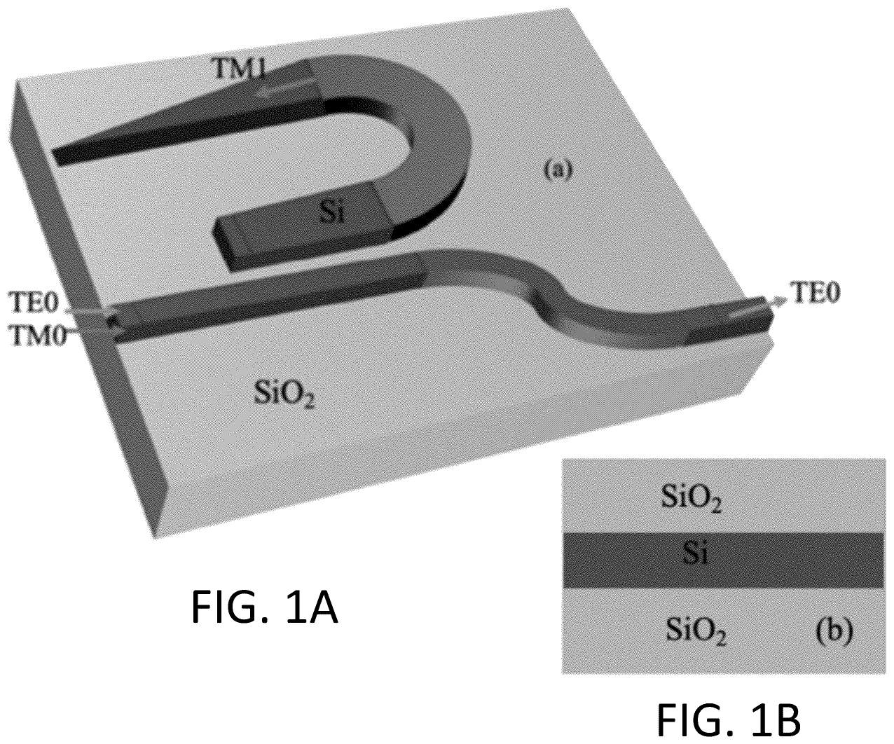

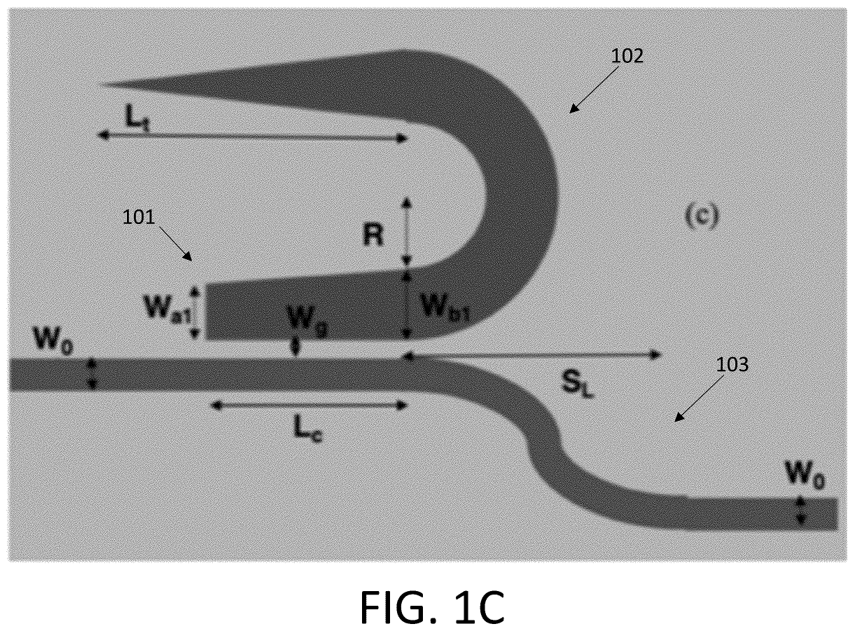

An exemplary TE-pass polarizer of the present invention is shown in FIGS. 1A-1C. In one embodiment, the design comprises an input waveguide with a width of Wo and a multimode waveguide 101 tapered from width Wₐ₁ to W_{b1}. In one embodiment, the input waveguide is tapered. The gap width and the coupling length are W_{g} and L_{c}, respectively. In one embodiment, the multimode waveguide 101 is followed by a low-loss 180 degree bend 102 with radius R and a linear terminator Lₜ, while, in one embodiment, an S-bend 103 with radius r follows the input waveguide. In various embodiments, different degrees of bend may be used for example between 90 degrees and 200 degrees, between 50 degrees and 200 degrees, between 120 degrees and 200 degrees, between 140 degrees and 200 degrees, between 140 degrees and 200 degrees, between 160 degrees and 200 degrees, between 170 degrees and 190 degrees, or about 180 degrees.

A novel feature of the invention is the use of a tapered waveguide 101 from Wₐ₁ to W_{b1}. This tapering is done to improve the bandwidth and make it fabrication tolerant. In various embodiments, the taper may have different sharpness, defined as a length of the taper relative to the starting width. For example, a ratio of length to starting width of a taper may be between 1:1 and 8:1, or between 1:1 and 6:1, or between 1:1 and 5:1, or between 1:1 and 4:1, or between 2:1 and 4:1, or between 2:1 and 5:1, or about 3:1 or about 4:1.

Another novel feature of the disclosed device is the termination of input waveguide with an S-bend 103 of radius r.

In one embodiment, thickness of the coupling material, which in some depicted embodiments comprises Si, on the substrate, which in some depicted embodiments comprises SiO₂, is 110 nm. In one embodiment, thickness of the coupling material is 220 nm. In one embodiment, thickness of the coupling material is 340 nm. In some embodiments, the thickness of the coupling material is about 100 nm, about 110 nm, about 120 nm, about 130 nm, about 140 nm, about 150 nm, about 160 nm, about 170 nm, about 180 nm, about 190 nm, about 200 nm, about 210 nm, about 220 nm, about 230 nm, about 240 nm, about 250 nm, about 260 nm, about 270 nm, about 280 nm, about 290 nm, about 300 nm, about 310 nm, about 320 nm, about 330 nm, about 340 nm, about 350 nm, about 360 nm, about 370 nm, about 380 nm, about 390 nm, about 400 nm, about 450 nm, about 500 nm, between 100 nm and 400 nm, between 100 nm and 340 nm, or any increments therebetween or which would be known by someone skilled in the art. In some embodiments, the coupling material may comprise other materials, for example other silicate materials, for example silicon nitride (SiN).

In one embodiment, a gap width (W_{g}) exists between the two waveguides of the disclosed device. In various embodiments, the gap width W_{g} is about 50 nm, about 60 nm, about 70 nm, about 80 nm, about 90 nm, about 100 nm, about 110 nm, about 110 nm, about 120 nm, about 130 nm, about 140 nm, about 150 nm about 160 nm, about 170 nm, about 180 nm, about 190 nm, about 200 nm, about 210 nm, about 220 nm, about 230 nm, about 240 nm, about 250 nm about 260 nm, about 270 nm, about 280 nm, about 290 nm, about 300 nm, about 310 nm, about 320 nm, or about 330 nm, between 40 nm and 400 nm, between 60 nm and 300 nm, or any increments therebetween or which would be known by someone skilled in the art.

An additional novel feature of the disclosed device is the termination of multimode waveguide with low-loss 180 degree bend 102 and a terminator.

The main differences from a conventional polarizer include a tapered ADC 101, a Low-Loss 180-degree bend 102 and a TE0 lossless S-Bend 103.

The main advantages of the design include CMOS compatibility, a simplicity of design, low fabrication sensitivity, a small footprint, broadband operation and high performance (Low Insertion Loss (IL), High Extinction Ratio (ER)).

Ultra-Compact Multimode Interference (MMI) coupler-based diplexer for Wavelength Division Multiplexing

Wavelength-Division multiplexing (WDM) is an essential way to increase the information capacity by increasing the number of channels in optical telecommunication systems. For systems such as fiber to the home (FTTH), dual-wavelength (de) multiplexers, also called diplexers, are a critical optical building block, and simplifying it is of great interest. Therefore, much attention has been given to (de) multiplexing two wavelengths in the 1310 and 1550 nm windows. Designing wavelength diplexers on a silicon-on-insulator (SOI) platform is attractive owing to its compatibility with complementary metal-oxide-semiconductor (CMOS) technology and the high integration density leading to low-cost and high-volume processing. Moreover, for on-chip optical interconnects, the silicon-based (de) multiplexers can increase the bandwidth, allowing to reach very high capacities using the WDM technology.

SOI diplexers, which (de) multiplex O-band and C-band signals, have been extensively demonstrated using diffractive gratings, microring resonators, directional couplers, and multimode interference (MMI) couplers. Diffractive grating couplers cannot work for on-chip interconnects and are limited only to fiber-to-chip optical exchange. Microring resonators have the advantage of filtering different wavelengths with a low insertion loss (IL) but suffer from narrow bandwidth and require additional temperature control. Directional couplers also have limited bandwidth and are very sensitive to fabrication errors. An MMI-based diplexer solution stands out among SOI (de) multiplexers; it provides a relatively low insertion loss and broad bandwidth.

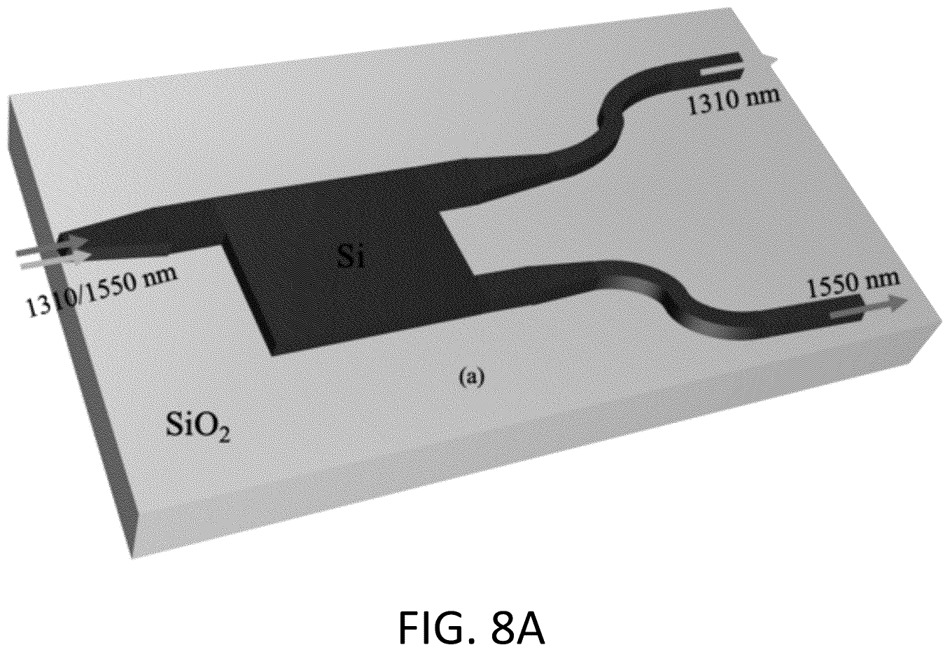

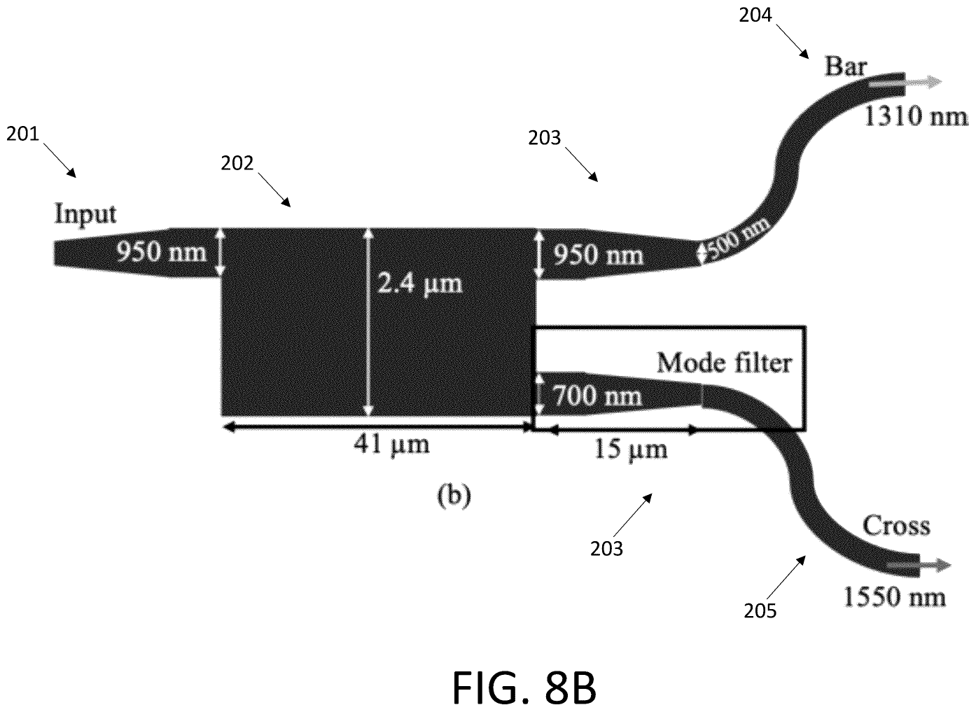

An exemplary device of the present invention is shown in FIGS. 8A-8B. In one embodiment, the device comprises an input channel 201, an MMI coupler 202, and two S-bent output channels 203, in which one is a bar-port 204, and the other is a cross-port 205.

A novel feature of the disclosed device is a compact design, comprised of an MMI 202 with a length (41 μm) equal to the first beat length of 1550 nm wavelength for the respective waveguide width. Traditionally, to demultiplex two wavelengths into two output ports, the length of the MMI coupler 202 is required to be a common multiple of the first self-imaging length for both the wavelengths. However, in certain embodiments, the presently disclosed device is designed at the first beat length of only 1550 nm. For example, in one embodiment, the MMI length is 41 μm and the width is 2.4 μm. In one embodiment, the MMI length is 65 μm and the width is 3 μm. In one embodiment, the MMI length is 90 μm and the width is 3.5 μm. In various embodiments, the length to width ratio is, but not limited to, between 10:1 and 30:1, between 10:1 and 20:1, between 20:1 and 30:1, about 10:1, about 11:1, about 12:1, about 13:1, about 14:1, about 15:1, about 16:1, about 17:1, about 18:1, about 19:1, about 20:1, about 21:1, about 22:1, about 23:1, about 24:1, about 25:1, about 26:1, about 27:1, about 28:1, about 29:1, about 30:1 any ratio therebetween or which would be known by someone skilled in the art.

In certain embodiments, another novel feature of the disclosed device is the output port widths are made asymmetric. For example, in one embodiment, the Bar port 204 width is 950 nm, while the cross-port 205 width is 700 nm. This is done to improve the performance of the device by filtering higher order mode excitations. In some embodiments, Bar- or cross-ports may have a width of between 500 nm and 1500 nm, or between 600 nm and 800 nm, or between 700 nm and 1100 nm, or between 900 nm and 1000 nm, or any other range in between. These ports are followed by output tapers with asymmetric starting widths (matching the bar and cross port widths) and symmetric end widths.

An additional novel feature of the disclosed device are S-bends 203 with a small radius added to cut-off higher-order modes. In certain embodiments, the radius of curvature of the S-Bends 203 may vary. In some embodiments, the radius of curvature is between 1 μm and 10 μm, or between 2 μm and 6 μm, or about 1 μm, about 1.5 μm, 2 μm, about 2.1 μm, about 2.2 μm, about 2.3 μm, about 2.4 μm, about 2.5 μm, about 2.6 μm, about 2.7 μm, about 2.8 μm, about 2.9 μm, about 3.1 μm, about 3.1 μm, about 3.2 μm, about 3.3 μm, about 3.4 μm, about 3.5 μm, about 3.6 μm, about 3.7 μm, about 3.8 μm, about 3.9 μm, about 4.0 μm, about 4.1 μm, about 4.2 μm, about 4.3 μm, about 4.4 μm, about 4.5 μm, about 4.6 μm, about 4.7 μm, about 4.8 μm, about 4.9 μm, about 5.0 μm, about 5.1 μm, about 5.2 μm, about 5.3 μm, about 5.4 μm, about 5.5 μm, about 5.6 μm, about 5.7 μm, about 5.8 μm, about 5.9 μm, about 6.0 μm, about 6.5 μm, or about 7.0 μm or any increments therebetween.

Several MMI based diplexers are reported in literature. However, the footprint of these devices is rather large and is on the order of hundreds of microns. To demultiplex two wavelengths into two output ports, the length of the MMI coupler is required to be a common multiple of the first self-imaging length for both the wavelengths, a requirement that increases the device size. But for silicon photonics, compactness is one of the key features leading to high integration density. MMI diplexers based on ridge waveguides, slot waveguides, subwavelength structures, inverse design algorithms, and photonic crystals have been introduced to shrink the length. Nevertheless, the footprint achieved with ridge and slot waveguides is still not very compact, with a transmission recorded only in the narrowband. Also, some schemes (subwavelength, inverse design, and photonic crystals) reduce the reliability during fabrication when commercial 193 nm UV lithography is used. Moreover, many of these MMIs lack experimental validation. Finally, for passive FTTH networks, ITU-T G.983 recommends wide bandwidth for 1310 nm and 1550 nm wavelengths which is challenging to satisfy using previously reported devices.

In some embodiments, the disclosed MMI-based diplexer is fully CMOS compatible with a device length of only 61 μm. In some embodiments, the length of the input and output ports are about 10 μm. The design concept is based on regular single etch strip waveguides. The MMI 202 is designed at the first imaging length for 1550 nm wavelength and optimized to demultiplex both 1310 nm and 1550 nm light with a high extinction ratio. A low insertion loss (<1 dB), high extinction ratio (>20 dB) and wide 3 dB bandwidth (100 nm) is measured for both the 1310 nm and 1550 nm wavelengths.

The disclosed device is a (de) multiplexer and is widely in demand for increasing the channel capacity in optical communication systems. Therefore, in some embodiments, devices disclosed herein may be used in fiber-optic communication. Also, because certain embodiments are CMOS compatible, they may be used in optical interconnects for data centers.

The disclosed MMI 202 uses the approach of selecting the first self-image for 1550 nm wavelength, which results immediately in a compact footprint. Then, to demultiplex the 1310 nm wavelength, the output ports (204,205) are made asymmetric, and S-bends 203are added to filter higher-order excitations. The device is based on simple strip waveguides with a single etch step, being CMOS compatible and less variation sensitive due to its simplicity.

The main differences between some embodiments of the disclosed device and conventional multimode interference couplers are that the length of MMI 202 is the first self-image method for the longer wavelength, there is asymmetry in the output port dimensions, output tapers with asymmetric starting widths (matching the bar and cross widths) and symmetric end widths, output channels with S-Bends 203, a strip waveguide with single etch step and no subwavelength grating structures.

Some advantages of certain embodiments of the disclosed device include CMOS compatibility, design simplicity, low fabrication sensitivity, a small footprint and broadband operation.

### Experimental Examples

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

Without further description, it is believed that one of ordinary skill in the art can, using the preceding description and the following illustrative examples, make and utilize the system and method of the present invention. The following working examples therefore, specifically point out the exemplary embodiments of the present invention, and are not to be construed as limiting in any way the remainder of the disclosure.

### Example 1: Compact and Broadband Silicon TE-Pass Polarizer Based on Tapered Directional Coupler

Silicon on insulator (SOI) platform for implementing photonic integrated circuits (PICs) is popular due to its compatibility with complementary metal-oxide-semiconductor (CMOS) processes (R. Soref, IEEE Journal of Selected Topics in Quantum Electronics 12 (6), 1678-1687 (2006)), which facilitate low-cost high volume fabrication. The SOI platform offers a large refractive index contrast which causes strong optical confinement in the silicon waveguide and thus facilitates ultra-compact devices and circuits. However, due to the same reason, the polarization dispersion is also significant in the silicon waveguides (Z. Mohammed et al., Applied Sciences 11 (5), 2366 (2021). In most planar waveguide cross-sections, the fundamental modes (TE and TM) have different effective & group indices, mode profiles, and confinement factors. Therefore, it is challenging to design silicon photonic devices that can function for both TE and TM fundamental modes. The most common practice is to optimize the PIC design with either of the two polarizations (mostly TE). The other polarization (mostly TM) is then blocked. Any fractions of unwanted cross-polarization may cause severe performance degradations in silicon photonic devices and circuits (H. Fukuda et al., Opt. Express, OE 16 (7), 4872-4880 (2008)).

A single-mode fiber supports both the fundamental TE and TM modes and can introduce cross-polarization into the circuit. Such a situation occurs when light is coupled into the silicon chip using edge coupler (nano inverse taper) based spot-size converters. An edge coupler based on inverse taper couples both the polarization states of the fiber. Therefore, cross-polarization can be introduced to the chip. Efficient external control of polarization is required to block unwanted polarization states. The efficiency of polarization control is not a concern when fiber grating couplers are used to couple the light. Grating couples independently act as polarizers allowing only one state of light to couple to the chip. However, grating couplers have limited bandwidth and cannot be used universally with PICs. In addition to fiber coupling with edge couplers, cross-polarization can also occur in polarization diversity devices such as polarization rotators and polarization beam splitters with imperfect rotation (D. Dai and H. Wu, Opt. Lett., OL 41 (10), 2346-2349 (2016); W. D. Sacher et al., Opt. Express, OE 22 (4), 3777-3786 (2014); D. Dai and J. E. Bowers, Nanophotonics 3 (4-5), 283-311 (2014); D. Dai et al., Laser & Photonics Reviews 7 (3), 303-328 (2013)). In both cases, an on-chip polarizer is greatly desired to block cross-polarization, thus improving the performance. The key features in a high-performing polarizer are low insertion loss, high extinction ratio, fabrication robustness, and compact footprint. Since CMOS compatibility is a key merit of silicon photonics, it is highly advantageous that polarizers are designed using CMOS compatible materials and processes. In literature, many different TE-pass and TM-pass polarizers are demonstrated using the concepts of the subwavelength grating (SWG) (X. Guan et al., Opt. Lett., OL 39 (15), 4514-4517 (2014)), photonic crystal (D. W. Kim et al., Opt. Express, OE 24 (19), 21560-21565 (2016); Y. Cui et al., in 2007 7th IEEE Conference on Nanotechnology (IEEE NANO) (2007), pp. 1093-1096), hybrid silicon plasmonic (Y. Huang et al., Opt. Express, OE 21 (10), 12790-12796 (2013); X. Sun et al., Opt. Lett., OL 37 (23), 4814-4816 (2012)), graphene (C. Pei et al., IEEE Photonics Technology Letters 27 (9), 927-930 (2015)), and asymmetric directional coupler (ADC) (H. Xu and Y. Shi, IEEE Photonics Technology Letters 29 (11), 861-864 (2017)). However, the fabrication of SWG structures and photonic crystals is challenging. The minimum feature size required by SWGs is not compatible with 193 nm deep ultraviolet (DUV) lithography. Due to scattering in the grating, the polarizers with SWG structures have high insertion loss. Similarly, photonic crystals-based polarizers are reported to suffer from high losses. With a plasmonic waveguide, polarizers can be realized in a compact footprint. Nevertheless, the insertion loss is still significant, and plasmonic structures require specific metals. Though the fabrication of ADC-based polarizers is simple, it has limited bandwidth (˜ 30 nm) due to the wavelength sensitivity of conventional directional coupler (DC). Furthermore, any fabrication error introduces phase mismatching, resulting in deviations in the designed coupling wavelength. A tapered DC is an efficient design that relaxes fabrication tolerance and bandwidth limitation of conventional DCs. It has been used in devices such as polarization splitters and rotators, mode multiplexers, and 3 dB couplers (Y. Ding et al., Opt. Express, OE 21 (8), 10376-10382 (2013); Y. Ding et al., Opt. Express, OE 20 (18), 20021-20027 (2012); Y. Luo et al., Sci Rep 6 (1), 23516 (2016); B. Paredes et al., IEEE Photonics Journal 13 (3), 1-9 (2021); B. Paredes et al., in 2021 Optical Fiber Communications Conference and Exhibition (OFC) (2021), pp. 1-3.). Disclosed herein is the first TE-pass polarizer using the concept of tapered DC on the SOI platform. A high-performing polarizer is also demonstrated by cascading two tapered TE-pass polarizers. The cascaded polarizer offers ultra-broad bandwidth, high extinction ratio, fabrication robustness with an acceptable increase in the insertion loss and the footprint.

An example embodiment of a TE-pass polarizer is depicted in FIGS. 1A-1C. As shown in FIG. 1B, the design is based on an SOI platform with silicon waveguide thickness of 220 nm, box oxide of 2 μm, and top cladding oxide of 2.2 μm. The TE-pass polarizer included an input waveguide (Wo width) and a multimode waveguide tapered from Wₐ₁ to W_{b1}. The coupling gap and length are W_{g} and L_{c}, respectively. A 180-degree bend follows the multimode waveguide (radius R) and is terminated with a linear taper (length Lₜ). The linear taper is referred to as ‘terminator’ herein. In contrast, the input waveguide is followed by an S-bend with radius r, routing TE0 mode to the output port.

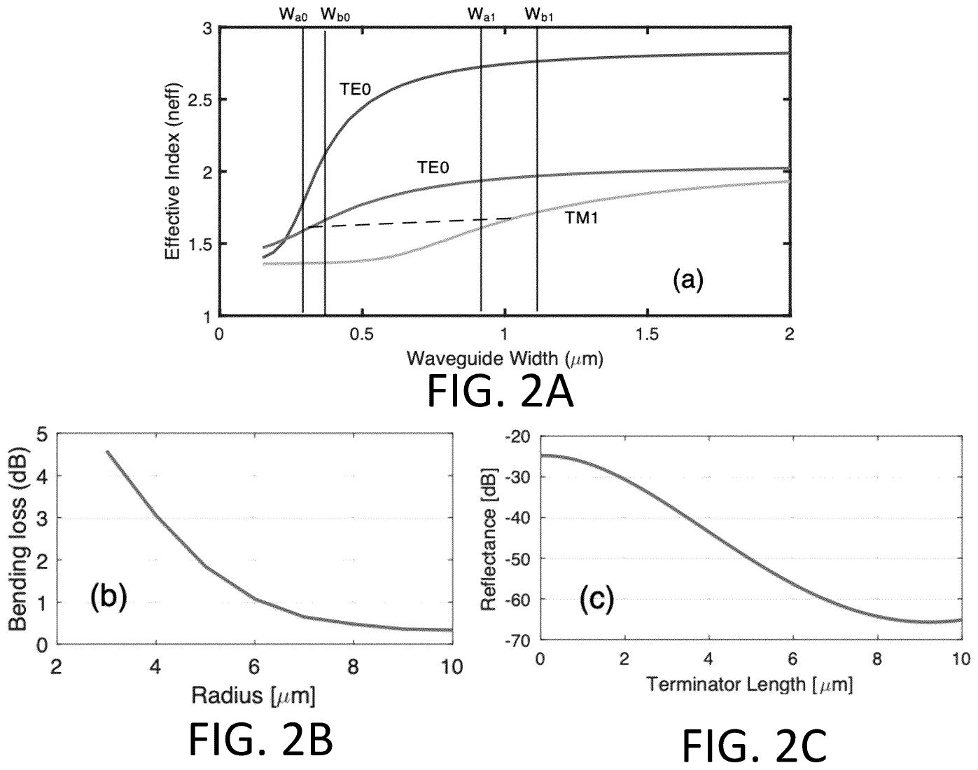

The operation of the disclosed TE-pass polarizer relies on the phase-matching principle of the DC coupler. The unwanted TM0 mode in the input waveguide is coupled as TM1 mode in the multimode waveguide. Such TM0-TM1 coupling is based on satisfying the phase-matching condition between the waveguides in a conventional DC. However, fabrication errors and wavelength deviations can easily destroy this condition. A fabrication-induced width deviation error of Δw will result in a more significant effective refractive index deviation Δ_{neff}, as shown in FIG. 2A. The larger the slope difference of Δ_{neff}, the easier it is for the phase-matching condition to be destroyed. To overcome the limitations of fabrication and wavelength sensitivity, the width of the wide waveguide is tapered in the disclosed design. Tapering the multimode waveguide from Wₐ₁ to W_{b1} will result in a width deviation tolerance of Wₐ₀ and W_{b0} for the narrow waveguide (single-mode waveguide). Hence, a phase-matching position can always be established along the tapered section of the DC.

Consequently, tapering the multimode waveguide will also increase the wavelength window for which the phase-matching condition is satisfied. The excited TM1 mode is channeled away from the input waveguide using a low-loss 180-degree bend and scattered in the terminator section. Furthermore, an S-bend is added to the input waveguide after the coupling region for filtering any uncoupled TM0 mode. On the other hand, the launched TE0 mode will pass through the coupling section uncoupled to the tapered waveguide due to phase mismatch. The S-bend is lossless for the TE0 mode. In this way, the disclosed device acts as a TE-pass polarizer allowing only TE0 mode and blocking the unwanted TM0 mode.

FIG. 2A shows the calculated effective indices (n_{eff}) of the eigenmodes in the SOI waveguide as a function of the waveguide width. The width of the input single-mode waveguide is chosen to be W₀=400 nm. The width of the multimode waveguide is then determined as W₁=1075 nm according to the phase-matching condition. In the disclosed design, the multimode waveguide is tapered from Wₐ₁=980 nm to W_{b1}=1170 nm. The +95 nm width variation around 1075 nm ensures tolerance to any deviation in width. The resulting coupling length is L_{c}=5 μm.

The transmission of TM1 mode is turned using a 180° bend and finally converted to radiation modes in the terminator section. The loss calculation with respect to the radius (R) is shown in FIG. 2B. The bending region is very close to the input waveguide, and selecting a very sharp bend can excite radiation modes which can cause cross-coupling. Therefore, a radius R=6 μm is selected, which gives the best tradeoff between loss and footprint. The terminator length is optimized to minimize reflection, and a length Lₜ=8 μm is selected (FIG. 2C). For the guided TE0 mode, an S-bend with radius r=5 μm and length S_{L}=7 μm is added in the propagating section of the device. This further enhances the extinction ratio by filtering any residual TM0 mode present in the input waveguide. The total length of the designed structure is Lₜₒₜₐₗ=L_{c}+SL=13 μm.

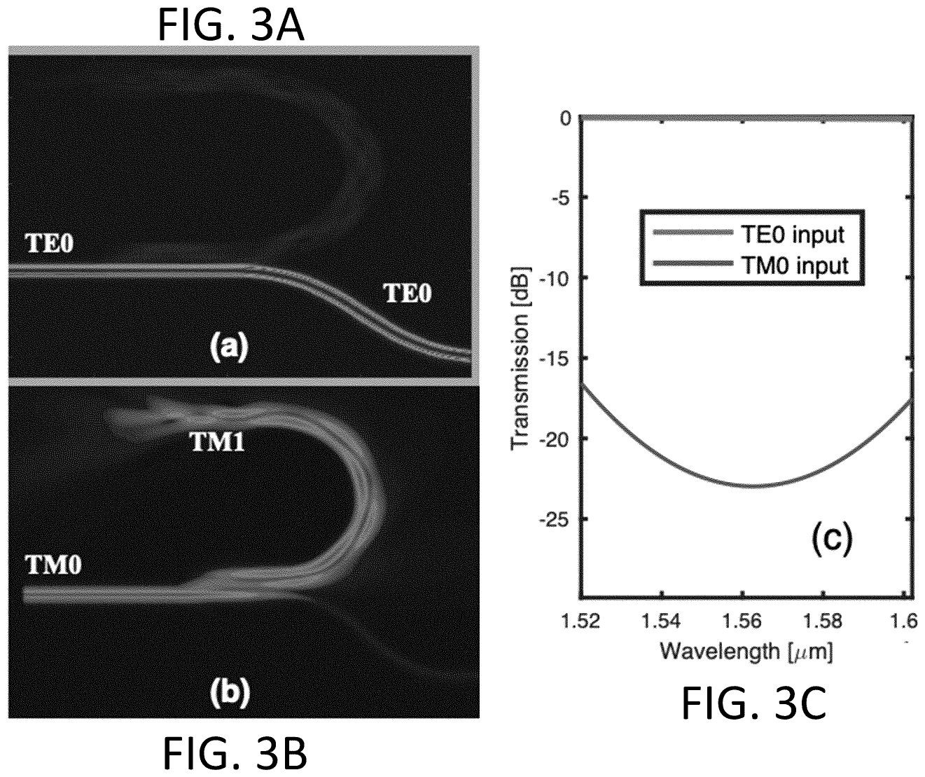

Finite-Difference Time-Domain 3D simulations (3D FDTD) were performed to obtain beam profiles of the disclosed device. The simulations are done at a central wavelength of 1550 nm. FIG. 3A shows that the input TE0 mode passes through the coupling region uncoupled and is collected at the output with negligible loss. In contrast, the input TM0 mode is efficiently coupled as TM1 mode in the tapered multimode waveguide and scattered in the terminator region through a 180-degree bending (FIG. 3B). The broadband transmission spectra are calculated using 3D FDTD and shown in FIG. 3C. The insertion loss for TE mode is IL<0.1 dB, and the extinction ratio (ER) between TE and TM modes is better than 15 dB over a wide wavelength range from 1520 nm to 1600 nm. The ER is 23 dB at the central wavelength (1550 nm).

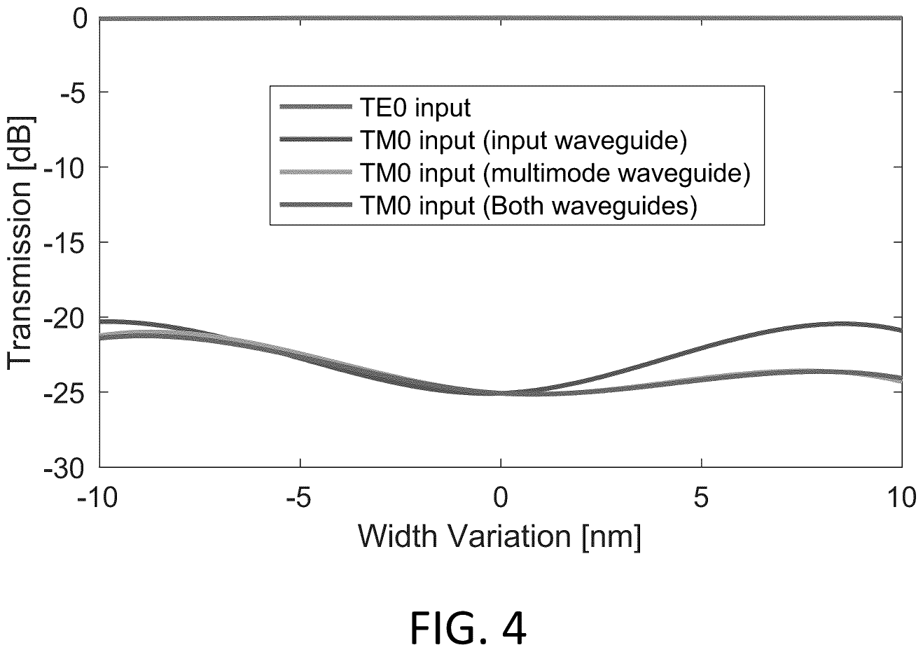

The fabrication tolerance is also analyzed by using the 3D-FDTD simulation method. To study the effect of fabrication variability, three cases are considered. In the first case, the width of the narrow waveguide is changed (W₀+Δw), while in the second case, the width of the wide waveguide is varied (Wₐ₁±Δw to W_{b1}±Δw). In the third case, both the narrow and wide waveguide widths are changed, where Δw is the width deviation due to fabrication error. The simulations are performed assuming a process deviation of ±10 nm. FIG. 4 shows the calculated performance of the disclosed TE-pass polarizer as a function of width deviation (Δw). For all three cases, the polarization extinction ratio is still >20 dB at the central wavelength. A constant center-to-center distance between the narrow and wide waveguides is considered. Therefore, the gap width (W_{g}) between the two waveguides changes accordingly with changes in the waveguide width.

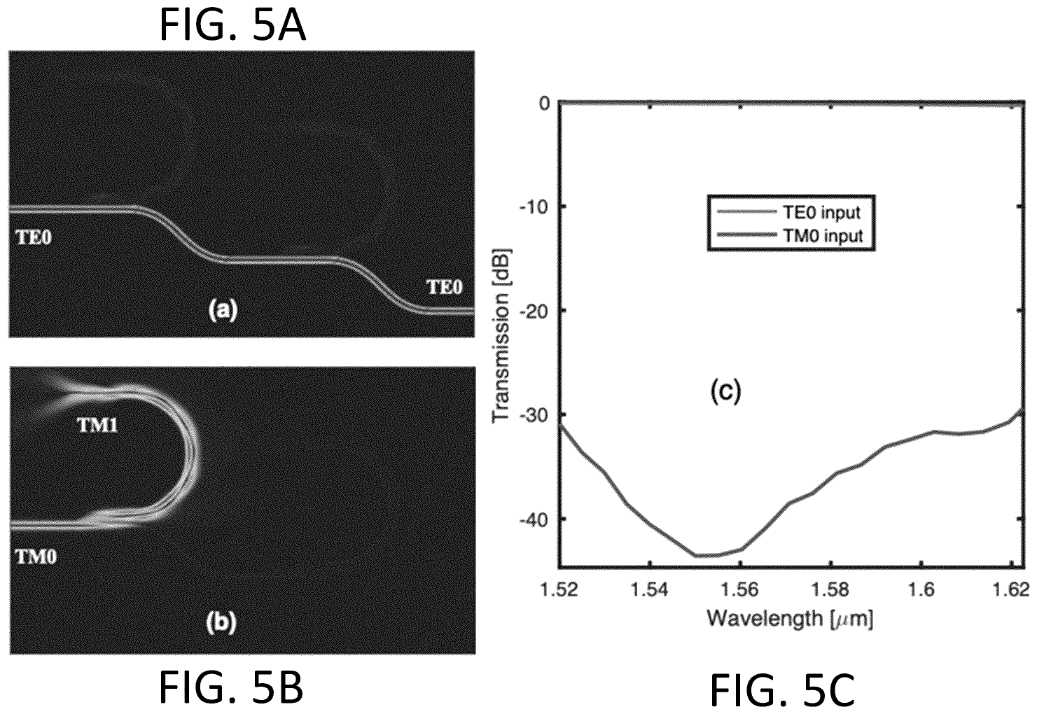

The performance can be further improved by cascading two of the disclosed TE-pass polarizers. By cascading, the transmission bands of the polarizers are multiplied. The beam propagation profiles (FIG. 5A-5B) and the transmission response (FIG. 5C for the cascaded polarizer (2-stage) are calculated using 3D FDTD. The extinction ratio is greatly enhanced as the residual TM mode is successfully filtered out. The extinction ratio at central wavelength is ER=43.5 dB for the 2-stage structure. Furthermore, over a 100 nm bandwidth covering the 1520-1620 nm wavelength range, an ER >30 dB and IL<0.26 dB is achieved.

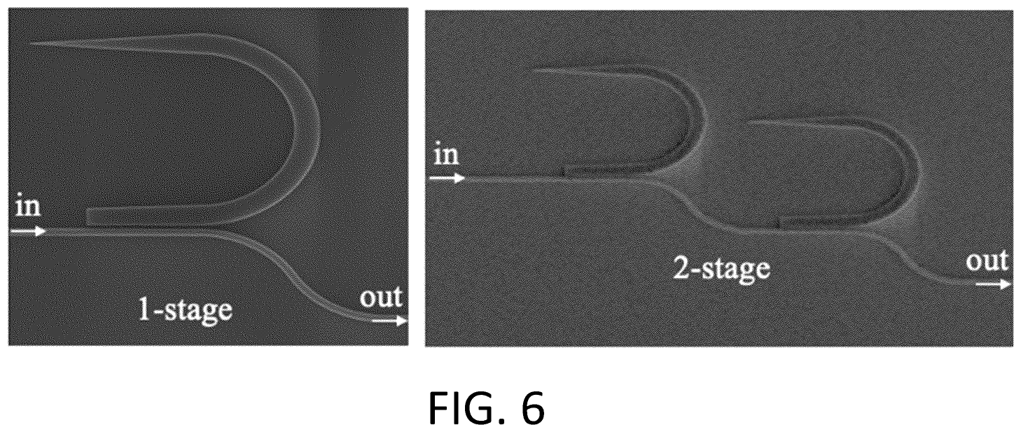

The designed TE-pass polarizers are fabricated using the NanoSOI fabrication process by Applied Nanotools Inc., based on direct-write 100 keV electron beam lithography technology. Electron microscope (SEM) micrographs of the fabricated device are shown in FIG. 6. A Keysight 81600B tunable laser was used as a source, and an external polarization controller was used for switching between TE0 and TM0 modes. The light was edge coupled from a lensed fiber into the silicon chip, though inverse taper-based spot size converter. A Keysight N7744A optical detector sensor measured the device wavelength response.

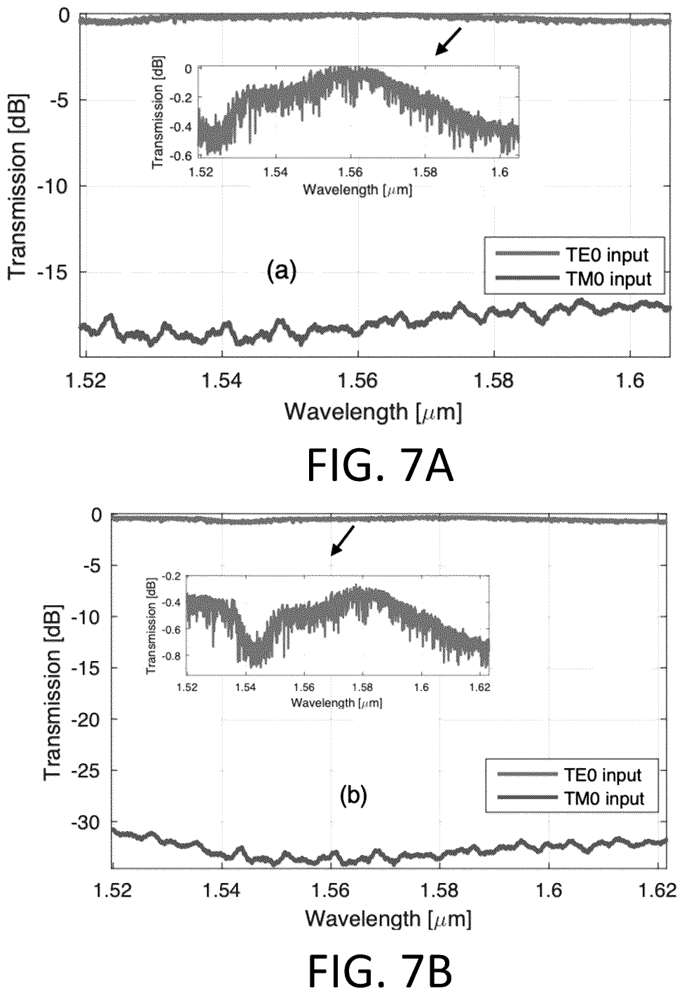

FIG. 7 shows the measured normalized transmission spectra for the polarizers. From the spectra, the measured extinction ratio and insertion loss at 1550 nm are IL=0.2 dB, ER=20 dB for 1-stage, respectively. The corresponding values for a 2-stage device are IL=0.52 dB and ER=33 dB. The increase in IL for both the polarizers is due to fabrication imperfection and sidewall roughness leading to high scattering. Furthermore, dimensional variations in waveguide width cause the ER to be lower, which matches our tolerance simulation. In the case of the 2-stage polarizer, the difference is higher due to the limited polarization extinction ratio of our setup.

For the 1-stage polarizer, over a bandwidth of 80 nm from 1520-1600, the IL is less than 0.44 dB with an ER better than 15 dB. In comparison, the 2-stage polarizer has a bandwidth of 100 nm with IL<0.89 dB and ER >30 dB. The device length is only 13 and 29 for the 1-stage and 2-stage polarizer structures, respectively. Table 1 summarizes performance matrices of reported on-chip polarizers. As shown in the comparison of Table 1, the demonstrated tapered DC-based polarizers exhibit low losses, wideband operation, and a high extinction ratio with compact footprints. The minimum feature size (200 nm) is fully compatible with 193 nm DUV.

The experiments demonstrated high-performance, fabrication tolerant, and novel TE-pass polarizers utilizing a tapered directional coupler on an SOI platform. The single-stage polarizer is measured to have an insertion loss <0.44 dB and an extinction ratio >15 dB over a 1520-1600 nm wavelength range. An extinction ratio >30 dB with insertion loss <0.89 dB over a bandwidth >100 nm is experimentally achieved by cascading two polarizers. The footprint of the 2-stage polarizer is still compact (˜ 29 μm) compared to most of the reported devices.

TABLE 1
Comparison of On-chip Polarizers

| | Footprint | IL | ER | BW |
|---|---|---|---|---|
| Waveguide Structure | (μm) | (dB) | (dB) | (nm) |
| SWG | 9 | <1 | 20 | 60 |
| Photonic Crystals | 4 | 1 | >30 | >50 |
| Nano plasmonic | 1 | 2.2 | 16 | 80 |
| Hybrid plasmonic | 30 | 2-3 | 23-28 | 60 |
| Graphene | 4000 | 9 | 27 | >80 |
| ADC | 29.39 | 1.04 | 15 | >80 |
| Tapered ADC [This work] | 13 | <0.45 | >15 | >80 |
| 2-stage Tapered ADC [This work] | 29 | <0.89 | >30 | >100 |

### Example 2: A CMOS Compatible Ultra-Compact MMI based Wavelength Diplexer

Wavelength-Division multiplexing (WDM) is an essential way to increase the information capacity by increasing the number of channels in optical telecommunication systems. For systems such as fiber to the home (FTTH), dual-wavelength (de) multiplexer, also called diplexer, is a critical optical building block, and simplifying it is of great interest. Therefore, much attention has been given to (de) multiplexing two wavelengths in the 1310 and 1550 nm windows (Y. Shi, J. Chen, and H. Xu, Sci. China Inf. Sci. 61 (8), 080402 (2018)). Designing wavelength diplexers on a silicon-on-insulator (SOI) platform is attractive owing to its compatibility with complementary metal-oxide-semiconductor (CMOS) technology and the high integration density leading to low-cost and high-volume processing. Moreover, for on-chip optical interconnects, the silicon-based (de) multiplexers can increase the bandwidth, allowing to reach very high capacities using the WDM technology (Y. Ding et al., Opt. Express, OE 21 (8), 10376-10382 (2013); B. Paredes et al., IEEE Photonics Journal 13 (3), 1-9 (2021); B. G. Lee et al., IEEE Photonics Technology Letters 20 (6), 398-400 (2008)).

The SOI diplexers, which (de) multiplex O-band and C-band signals, have been extensively demonstrated using diffractive gratings (G. Roelkens et al., Opt. Express, OE 15 (16), 10091-10096 (2007); C. R. Doerr et al., IEEE Photonics Technology Letters 21 (22), 1698-1700 (2009)), microring resonators (L. Xu et al., IEEE Photonics Technology Letters 24 (16), 1372-1374 (2012)), directional couplers (J. Chen et al., IEEE Photonics Technology Letters 29 (22), 1975-1978 (2017); J. Chen and Y. Shi, Journal of Lightwave Technology 35 (23), 5260-5264 (2017); H. Xu and Y. Shi, IEEE Photonics Technology Letters 29 (15), 1265-1268 (2017); Y. Shi et al., Journal of Lightwave Technology 27 (11), 1443-1447 (2009)), and multimode interference (MMI) couplers (J. Xiao et al., Opt. Express, OE 15 (13), 8300-8308 (2007); Y. Shi et al., IEEE Photonics Technology Letters 19 (22), 1789-1791 (2007); L. Liu et al., IEEE Photonics Technology Letters 29 (22), 1927-1930 (2017); L. Xu et al., Opt. Lett., OL 44 (7), 1770-1773 (2019); H. Yi et al., in Nanophotonics and Micro/Nano Optics (SPIE, 2012), 8564, pp. 175-180). Diffractive grating couplers cannot work for on-chip interconnects and are limited only to fiber-to-chip optical exchange. Microring resonators have the advantage of filtering different wavelengths with a low insertion loss (IL) but suffer from narrow bandwidth and require additional temperature control. Directional couplers also have limited bandwidth and are very sensitive to fabrication errors.

An MMI-based diplexer solution stands out among SOI (de) multiplexers; it provides a relatively low insertion loss and broad bandwidth. Several groups have reported diplexers based on MMI couplers. However, the footprint of these devices is rather large and is in the order of hundreds of microns. To demultiplex two wavelengths into two output ports, the length of the MMI coupler is required to be a common multiple of the first self-imaging length for both the wavelengths, a requirement that increases the device size (L. B. Soldano and E. C. M. Pennings, Journal of Lightwave Technology 13 (4), 615-627 (1995)). But for silicon photonics, compactness is one of the key features leading to high integration density. MMI diplexers based on ridge waveguides, slot waveguides, subwavelength structures, inverse design algorithms, and photonic crystals have been introduced to shrink the length. Nevertheless, the footprint achieved with ridge and slot waveguides is still not very compact (J. Xiao et al., Opt. Express, OE 15 (13), 8300-8308 (2007)), with a transmission recorded only in the narrowband. Also, some schemes (subwavelength, inverse design, and photonic crystals) reduce the reliability during fabrication when commercial 193 nm UV lithography is used (L. Liu et al., IEEE Photonics Technology Letters 29 (22), 1927-1930 (2017); L. Xu et al., Opt. Lett., OL 44 (7), 1770-1773 (2019); A. Y. Piggott et al., Nature Photon 9 (6), 374-377 (2015); Y. Ma et al., Opt. Express, OE 22 (18), 21521-21528 (2014)). Moreover, many of these MMIs lack experimental validation (J. Xiao et al., Opt. Express, OE 15 (13), 8300-8308 (2007); Y. Shi et al., IEEE Photonics Technology Letters 19 (22), 1789-1791 (2007); L. Liu et al., IEEE Photonics Technology Letters 29 (22), 1927-1930 (2017); Y. Ma et al., Opt. Express, OE 22 (18), 21521-21528 (2014)). Finally, for passive FTTH networks, ITU-T G.983 recommends wide bandwidth for 1310 nm and 1550 nm wavelengths which is challenging to satisfy using previously reported devices (Y. Shi, J. Chen, and H. Xu, Sci. China Inf. Sci. 61 (8), 080402 (2018)).

Here, experimentally demonstrated is a fully CMOS compatible MMI-based diplexer with a device length of only 41 μm. The design concept, which is based on regular single etch strip waveguides was previously reported with preliminary results (Z. Mohammed et al., in 2021 European Conference on Optical Communication (ECOC) (2021), pp. 1-3). The MMI is designed at the first imaging length for 1550 nm wavelength and optimized to demultiplex both 1310 nm and 1550 nm light with a high extinction ratio. A low insertion loss (<1 dB), high extinction ratio (>20 dB) and wide 3 dB bandwidth (100 nm) is measured for both the 1310 nm and 1550 nm wavelengths. An on-chip wavelength demultiplexing transmission experiment was also carried out with a non-return-to-zero (NRZ) on-off keying (OOK) signal modulated at 60 Gbit/s. The experimental results show clear eye diagrams for both channels. This is the first system demonstration of an on-chip MMI-based wavelength demultiplexer on an SOI platform.

### Device Design and Methodology

A schematic of the disclosed device is shown in FIGS. 8A-8B. The device is comprised of three parts: an input channel, an MMI coupler, and two S-bent output channels, in which one is the bar-port, and the other is cross-port. The waveguide design parameters used are as follows: the refractive index of silicon (Si) and oxide (SiO2) are 3.445 and 1.445, respectively. The diplexer is fabricated on an SOI platform with a 220 nm thick silicon layer, a 2.2 μm thick oxide cladding, and 2 μm thick box oxide.

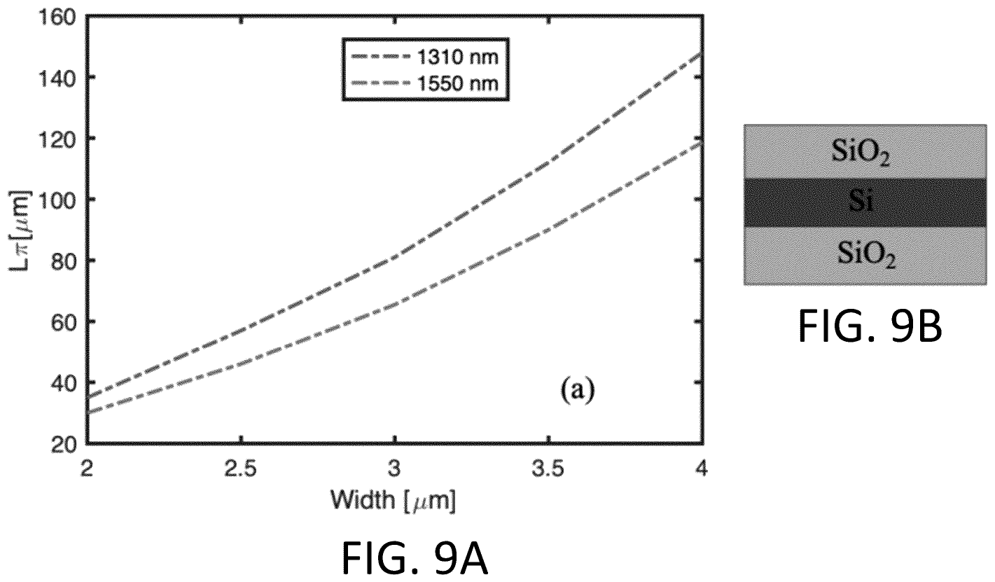

The first step is to calculate beat length using an Eigenmode expansion solver (EME). FIG. 9A shows the beat lengths for both 1550 nm and 1310 nm wavelengths as a function of the silicon waveguide width. In a conventional MMI, the interference between excited optical modes forms a multifold image of the input field at periodic propagation distances (self-imaging). N fold images are produced at the image plane (MMI length) at L=3pL_{π}/N, p=0,1,2 . . . . Here, L_{π} is the beat length of the multimode region given by:

$${L}_{π} = \frac{π}{( {β}_{0} - {β}_{1} )} \qquad Equation 1$$

where β₀ and β₁ are the propagation constant of the two lowest-order propagating modes. At odd multiples of the L_{π}, an image of the input field is formed at an anti-symmetric position (mirror image). On the other hand, at even multiples of L_{π}, an image is formed at identical positions, called a single image. Since the propagation constant is wavelength dependent, self-images will be produced at different planes for different working wavelengths. To separate the 1310/1550 nm wavelengths, the MMI demultiplexer uses the difference between the beat lengths at these wavelengths. The MMI length (LMMI) is adjusted to satisfy:

$${L}_{MMI} = r {L}_{π} ( 1310 ) = ( r + 1 ) {L}_{π} ( 1550 ) \qquad Equation 2$$

where r is an integer.

When the length of the MMI region satisfies Eq. (2), there will be a single and a mirror image formed for the two different wavelengths, i.e., the 1310 nm and 1550 nm bands, respectively (r is even in this case). Therefore, to demultiplex, the MMI coupler's length is required to be the common multiple of the first self-imaging lengths for two wavelengths. To fulfill this requirement, the device length has to match several odd or even number of the beat lengths for both wavelengths, which increases the overall size.

To make the design compact, the analysis begins by considering an MMI with a length equal to the first beat length of 1550 nm wavelength for the respective waveguide width. If the MMI is designed with such a selection, it results in 1550 nm light correctly guiding towards the cross port, and negligible power will be recorded at the bar port. Even though the 1310 nm wavelength will be strongly focused on the bar port, there will be some power guiding towards the cross port, affecting the performance. For a demultiplexer, the most critical performance metrics are the insertion loss (IL) and the extinction ratio (ER), which are defined as:

$$IL = - 10 log ( \frac{{P}_{i}}{{P}_{i n}} ) i = 1 , 2 \qquad Equation 3$$

$$ER = - 10 log ( \frac{{P}_{2}}{{P}_{1}} ) \qquad Equation 4$$

where Pᵢₙ is the total input power, P₁ and P₂ are the output power in the bar (cross) port and the cross (bar) port at 1310 nm (1550 nm).

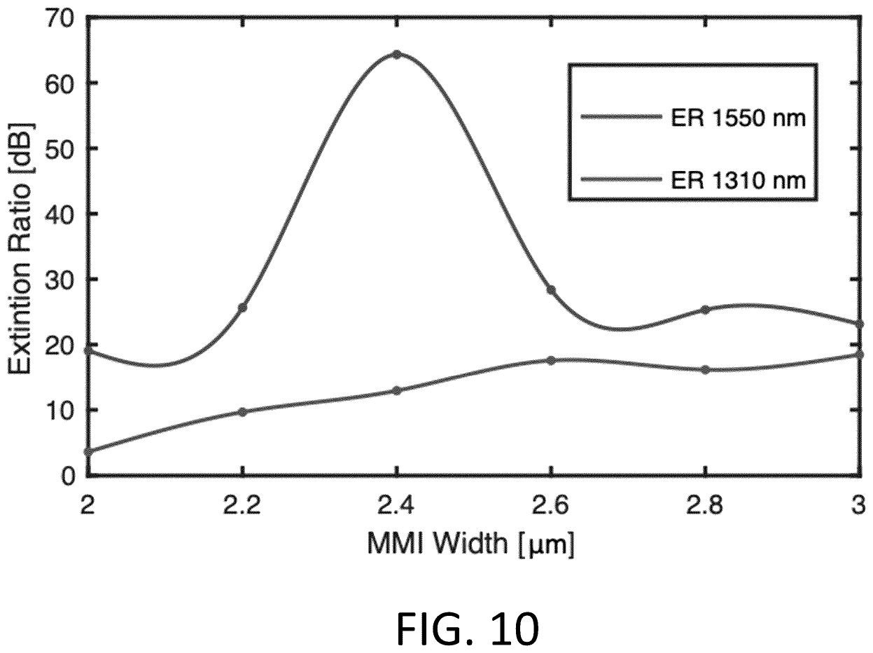

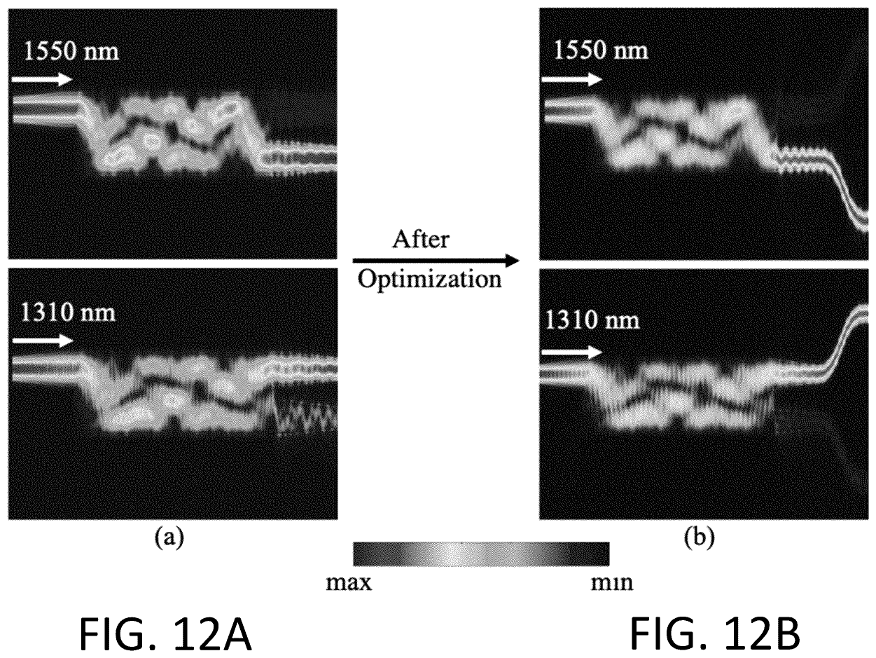

FIG. 10 shows the simulated ER of an MMI designed with a first image length corresponding to 1550 nm wavelength. Here the input and output port widths are symmetric with a width of 950 nm to ensure most of the input power is carried by the first few-order modes of the MMI coupler with small modal phase errors. As expected from the image theory, the ER of 1550 nm light is much better compared to 1310 nm wavelength. From FIG. 10, the MMI width that results in an optimum ER for 1550 nm wavelength is 2.4 μm, which corresponds to a beat length of 41 μm. At this beat length, the 1310 nm light suffers from a low ER of 12 dB [see FIG. 10]. As shown in FIG. 12A, ripples due to higher-order mode excitation can be seen for the 1310 nm wavelength as it exits the MMI at the output cross port, reducing the ER according to Equation 4.

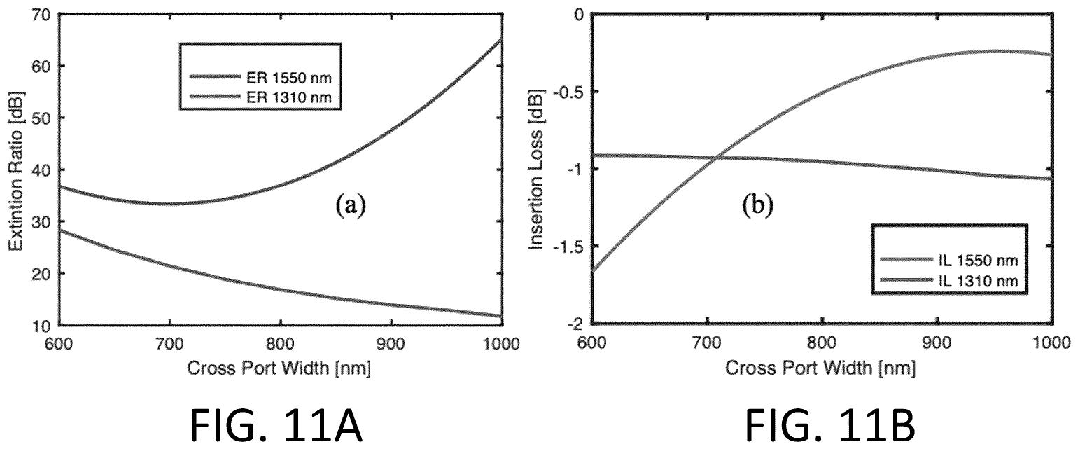

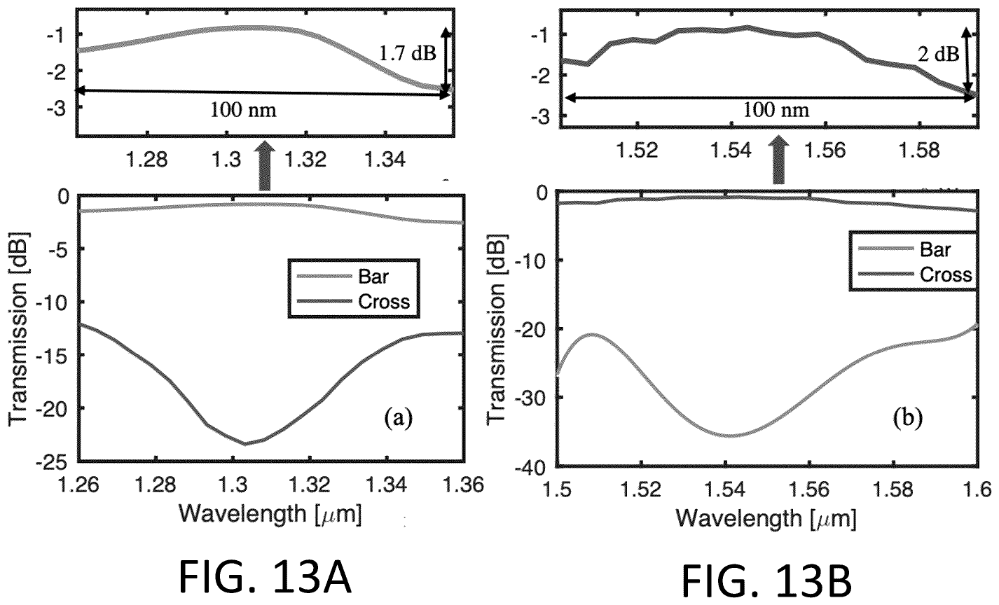

To improve the performance without increasing the MMI length, the cross-port width is reduced to filter out higher-order optical modes when O-band wavelength is injected. The optimum cross-port width is 700 nm which gives the best tradeoff between insertion loss and extinction ratio (FIG. 11A-11B). Additionally, S-bends are added to completely filter higher-order excitations. FIG. 12B shows the beam propagation of the final optimized device. The O-band and the C-band light are demultiplexed as desired. The O-band light is transmitted through the bar port while the C-band light is collected at the cross port. The simulated power transmission at the bar and the cross ports as a function of the wavelength bands from 1260-1360 nm and 1500-1600 nm are shown in FIG. 13A-13B. At the wavelength of 1310 nm, the IL and ER are 0.8 dB and 24 dB, respectively. At the wavelength of 1550 nm, the IL and ER are 0.81 dB and 41 dB, respectively. The ER of the 1550 nm band is better due to perfect imaging. Furthermore, the 3 dB bandwidth covers 100 nm near center wavelengths of both O- and C-bands. The beam propagation and broadband simulations are performed using 3D FDTD solver.

### Device Fabrication and Characterization

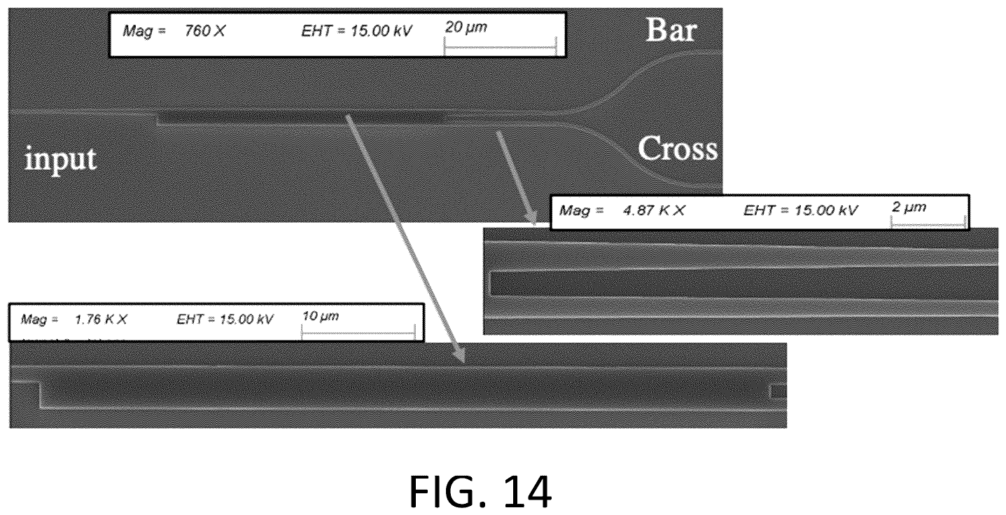

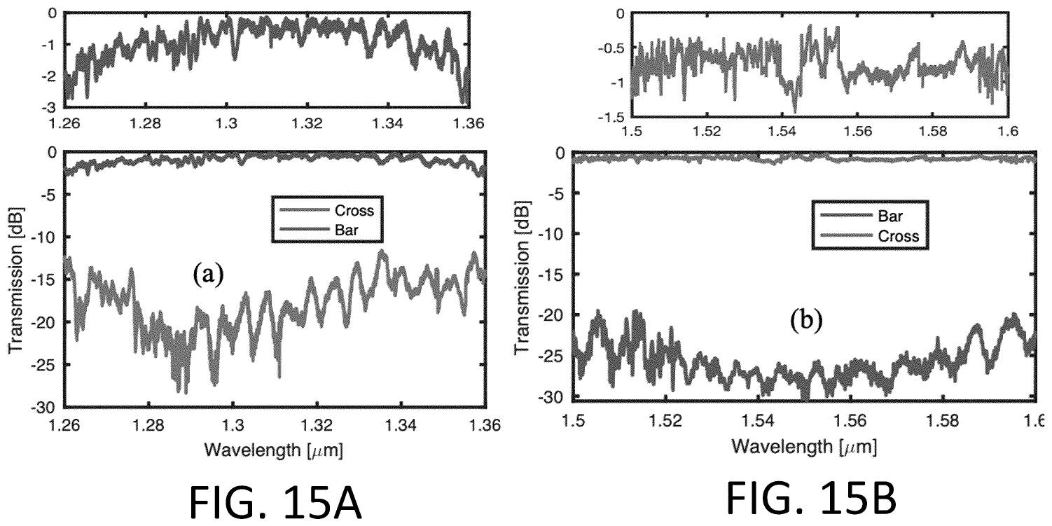

The designed diplexer is fabricated using the NanoSOI fabrication process by Applied Nanotools Inc., based on direct-write 100 keV electron beam lithography technology. This process uses an SOI wafer with a 220 nm thick silicon layer, hydrogen silsesquioxane (HSQ) resist, and anisotropic ICP-RIE etch process with chlorine. A 2 μm oxide cladding was deposited using a plasma-enhanced chemical vapour deposition (PECVD) process based on tetraethyl orthosilicate (TE0S) at 300° C. Scanning electron microscope (SEM) micrographs of the fabricated device are shown in FIG. 14. Edge couplers are used to couple light to the Silicon chip using lensed fibers. Two tunable Keysight 8100B laser sources (C-band and O-band lasers) and Keysight N7744A optical detector sensors are used to characterize the optical transmission response. An external polarization controller is used to maintain TE-polarization. The measurements are shown in FIG. 15A-15B after calibrating out the coupling loss of the edge couplers. The measured IL is around 0.85 dB for both 1310 nm and 1550 nm wavelengths. The ER of 1310 nm wavelength measures 23 dB, while the ER of 1550 nm is 30 dB. The discrepancy in ER for 1550 nm light from the simulations can be attributed to limited polarization extinction between the TE and TM mode of the input fibers. This can be improved with the use of grating couplers instead of edge couplers. A very wide 3 dB bandwidth is measured as seen from the two insets at the top of FIG. 15A-15B, which are magnified plots around 1310/1550 nm wavelengths. Both the ports have a bandwidth of 100 nm.

Table 2 shows the performance of the disclosed device compared to previously reported MMI-based (de) multiplexers. The demultiplexers based on slot and sandwiched silicon nitride waveguide are still relatively large and lacks experimental validation (J. Xiao et al., Opt. Express, OE 15 (13), 8300-8308 (2007); Y. Shi et al., IEEE Photonics Technology Letters 19 (22), 1789-1791 (2007)). Among all the MMI-based diplexers, the subwavelength-based MMI demultiplexer has excellent theoretical performance and is relatively compact. However, reliability is a concern when fabricated with standard UV lithography (L. Liu et al., IEEE Photonics Technology Letters 29 (22), 1927-1930 (2017)). The photonic crystal and strip waveguide (cascaded) based MMI have high insertion loss and a large footprint (L. Xu et al., Opt. Lett., OL 44 (7), 1770-1773 (2019); H. Yi et al., in Nanophotonics and Micro/Nano Optics (SPIE, 2012), 8564, pp. 175-180). Finally, most reported devices have a large footprint and lack experimental validation as they involve complex non-standard fabrication processes. In comparison, the disclosed wavelength (de) multiplexer is compact and based on a standard SOI process with a conventional single step etch strip waveguide.

TABLE 2
Performance comparison on MMI demultiplexer

| | | | | | | Extinction | |
|---|---|---|---|---|---|---|---|
| | | | | Insertion | | Ratio (ER)- | 3 dB |
| | | | | Loss (IL) | | 1310/ | Bandwidth- |
| | | Result | MMI | 1310/ | | 1550 | 1310/ |
| Ref. | Waveguide type | type | length | 1500 nm | | nm | 1550 nm |
| [Xiao et al.] | Slot waveguide | Simulation | 119.8 | <0.2 | dB | >25 dB | — |
| [Shi et al.] | Silicon/Silicon | Simulation | 363.5 | <0.7 | dB | >20 dB | — |
| | Nitride | | | | | | |
| [Liu et al.] | Subwavelength | Simulation | 43.4 | <0.1 | dB | >20 dB | >120 nm |
| | grating | | | | | | |
| [Xu et al.] | Photonic Crystal | Experiment | 108.5 | <4 | dB | >19 dB | — |
| [Yi et al.] | Strip Waveguide/ | Experiment | 117 | 5 | dB | >10 dB | — |
| | (Cascaded) | | | | | | |
| This work | Strip Waveguide | Experiment | 41 | 0.85 | dB | >23 dB | 100 nm |

### System Demonstration

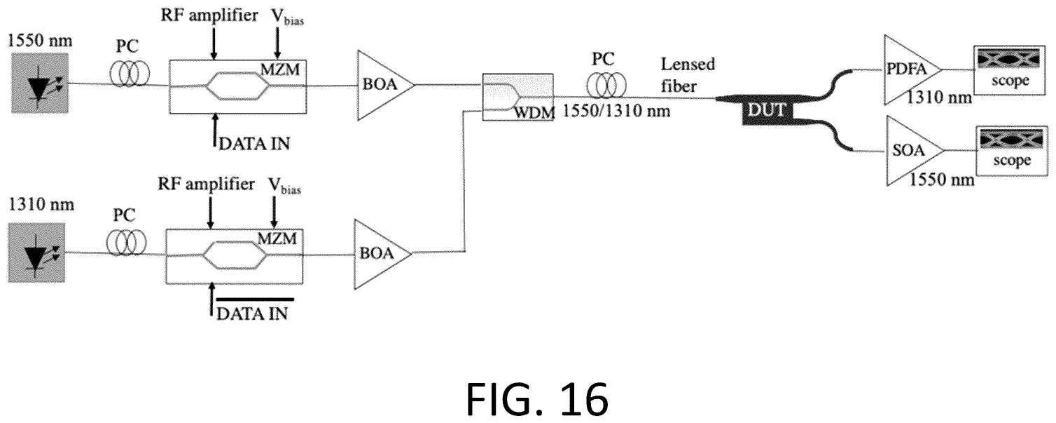

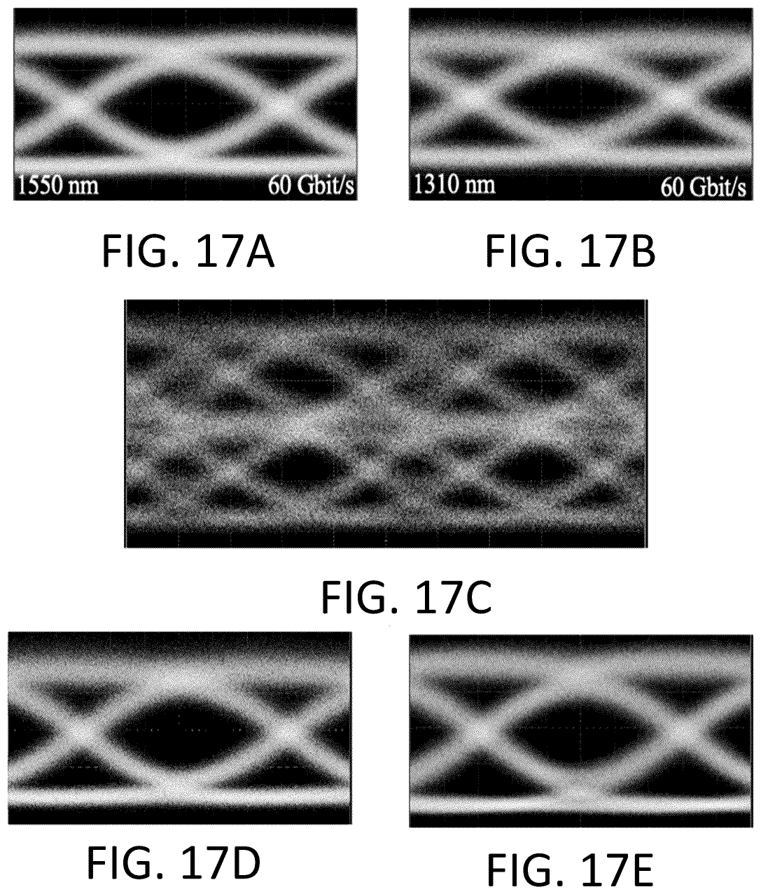

The fabricated chip was further employed for the on-chip wavelength demultiplexing experiment. FIG. 16 shows the transmission test experimental setup. The C-band tunable laser source centered at 1550 nm is connected to a polarization controller. It is then modulated at 60 Gbit/s in the NRZ-OOK scheme with a known random binary pattern of 231-1 generated from Keysight 64 Gbaud pattern generator M8045A. The modulation is performed with Thorlabs LN05S 40 GHz intensity Mach-Zehnder modulator. The optical signal is then pre-amplified with a polarization-maintaining booster optical amplifier (Thorlabs S9FC1004P). The same configuration is implemented for the O-band tunable laser centered at 1310 nm, modulated with IxBlue Mx1300-LN-40 40 GHz intensity modulator. The optical signal is pre-amplified with a polarization-maintaining booster optical amplifier (Thorlabs S9FC1132P). The measured eye diagrams for the pre-amplified 1550 nm and 1310 nm optical signals are shown in FIG. 17A and FIG. 17B, respectively. Both signals are then multiplexed with a commercial fiber based WDM into one single fiber connected to a polarization controller and coupled to the disclosed silicon diplexer (DUT) with a lensed fiber. The eye diagram of multiplexed 1550 nm/1310 nm is shown in FIG. 17C. This diplexer acts as an on-chip demultiplexer with the 1550 nm signal routed to the cross-port and the 1310 nm wavelength to the bar-port. Each output of the DUT is amplified with a polarization-insensitive semiconductor optical amplifier (Thorlabs S7FC1013S) and a single-mode Praseodymium-doped fiber amplifier (PDFA100) at 1550 nm and 1310 nm wavelength, respectively. A Keysight Infinium DCA-X 86100D wide-bandwidth oscilloscope is used to capture the eye diagrams. As shown in FIG. 17D-17E the corresponding demultiplexed signals exhibit clear eye diagrams, which confirms the high extinction ratio of the device.

An ultra-compact (41 μm) 1310/1550 nm wavelength MMI-based diplexer is demonstrated on the SOI platform. The minimum critical dimension of the device is fully compatible with 193 nm UV lithography. A compact footprint is achieved by designing and optimizing the MMI at the first beat length of 1550 nm wavelength. Measurement shows a low IL (<1 dB) and high ER (>20 dB) for both the wavelengths. System experiments have been carried out for on-chip wavelength demultiplexing application at 60 Gbit/s, showing clear eye diagrams for the demultiplexed channels.

### REFERENCES

The following publications are incorporated herein by reference in their entireties.

R. Soref, “The Past, Present, and Future of Silicon Photonics,” IEEE Journal of Selected Topics in Quantum Electronics 12 (6), 1678-1687 (2006).

Z. Mohammed, B. Paredes, and M. Rasras, “Effect of Process Parameters on Mode Conversion in Submicron Tapered Silicon Ridge Waveguides,” Applied Sciences 11 (5), 2366 (2021).

H. Fukuda, K. Yamada, T. Tsuchizawa, T. Watanabe, H. Shinojima, and S. Itabashi, “Silicon photonic circuit with polarization diversity,” Opt. Express, OE 16 (7), 4872-4880 (2008).

D. Dai and H. Wu, “Realization of a compact polarization splitter-rotator on silicon,” Opt. Lett., OL 41 (10), 2346-2349 (2016).

W. D. Sacher, T. Barwicz, B. J. F. Taylor, and J. K. S. Poon, “Polarization rotator-splitters in standard active silicon photonics platforms,” Opt. Express, OE 22 (4), 3777-3786 (2014).

D. Dai and J. E. Bowers, “Silicon-based on-chip multiplexing technologies and devices for Peta-bit optical interconnects,” Nanophotonics 3(4-5), 283-311 (2014).

D. Dai, L. Liu, S. Gao, D.-X. Xu, and S. He, “Polarization management for silicon photonic integrated circuits,” Laser & Photonics Reviews 7 (3), 303-328 (2013).

X. Guan, P. Chen, S. Chen, P. Xu, Y. Shi, and D. Dai, “Low-loss ultracompact transverse-magnetic-pass polarizer with a silicon subwavelength grating waveguide,” Opt. Lett., OL 39 (15), 4514-4517 (2014).

D. W. Kim, M. H. Lee, Y. Kim, and K. H. Kim, “Ultracompact transverse magnetic mode-pass filter based on one-dimensional photonic crystals with subwavelength structures,” Opt. Express, OE 24 (19), 21560-21565 (2016).

Y. Cui, Q. Wu, E. Schonbrun, M. Tinker, J.-B. Lee, and W. Park, “Silicon-based 2D slab nano photonic crystal TM polarizer in telecommunication wavelength,” in 2007 7th IEEE Conference on Nanotechnology (IEEE NANO) (2007), pp. 1093-1096.

Y. Huang, S. Zhu, H. Zhang, T.-Y. Liow, and G.-Q. Lo, “CMOS compatible horizontal nanoplasmonic slot waveguides TE-pass polarizer on silicon-on-insulator platform,” Opt. Express, OE 21 (10), 12790-12796 (2013).

X. Sun, M. Z. Alam, S. J. Wagner, J. S. Aitchison, and M. Mojahedi, “Experimental demonstration of a hybrid plasmonic transverse electric pass polarizer for a silicon-on-insulator platform,” Opt. Lett., OL 37 (23), 4814-4816 (2012).

C. Pei, L. Yang, G. Wang, Y. Wang, X. Jiang, Y. Hao, Y. Li, and J. Yang, “Broadband Graphene/Glass Hybrid Waveguide Polarizer,” IEEE Photonics Technology Letters 27 (9), 927-930 (2015).

H. Xu and Y. Shi, “On-Chip Silicon TE-Pass Polarizer Based on Asymmetrical Directional Couplers,” IEEE Photonics Technology Letters 29 (11), 861-864 (2017).

Y. Ding, J. Xu, F. D. Ros, B. Huang, H. Ou, and C. Peucheret, “On-chip two-mode division multiplexing using tapered directional coupler-based mode multiplexer and demultiplexer,” Opt. Express, OE 21 (8), 10376-10382 (2013).

Y. Ding, L. Liu, C. Peucheret, and H. Ou, “Fabrication tolerant polarization splitter and rotator based on a tapered directional coupler,” Opt. Express, OE 20 (18), 20021-20027 (2012).

Y. Luo, Y. Yu, M. Ye, C. Sun, and X. Zhang, “Integrated dual-mode 3 dB power coupler based on tapered directional coupler,” Sci Rep 6 (1), 23516 (2016).

B. Paredes, Z. Mohammed, J. Villegas, and M. Rasras, “Dual-Band (O amp; C-Bands) Two-Mode Multiplexer on the SOI Platform,” IEEE Photonics Journal 13 (3), 1-9 (2021).

B. Paredes, Z. Mohammed, J. Villegas, and M. Rasras, “An Ultra-Broadband Two-Mode Transverse-Electric Multiplexer in SOI platform,” in 2021 Optical Fiber Communications Conference and Exhibition (OFC) (2021), pp. 1-3.

Y. Shi, J. Chen, and H. Xu, “Silicon-based on-chip diplexing/triplexing technologies and devices,” Sci. China Inf. Sci. 61 (8), 080402 (2018).

Y. Ding, J. Xu, F. D. Ros, B. Huang, H. Ou, and C. Peucheret, “On-chip two-mode division multiplexing using tapered directional coupler-based mode multiplexer and demultiplexer,” Opt. Express, OE 21 (8), 10376-10382 (2013).

B. Paredes, Z. Mohammed, J. Villegas, and M. Rasras, “Dual-Band (O amp; C-Bands) Two-Mode Multiplexer on the SOI Platform,” IEEE Photonics Journal 13 (3), 1-9 (2021).

B. G. Lee, X. Chen, A. Biberman, X. Liu, I.-W. Hsieh, C.-Y. Chou, J. I. Dadap, F. Xia, W. M. J. Green, L. Sekaric, Y. A. Vlasov, R. M. Osgood, and K. Bergman, “Ultrahigh-Bandwidth Silicon Photonic Nanowire Waveguides for On-Chip Networks,” IEEE Photonics Technology Letters 20 (6), 398-400 (2008).

G. Roelkens, D. V. Thourhout, and R. Baets, “Silicon-on-insulator ultra-compact duplexer based on a diffractive grating structure,” Opt. Express, OE 15 (16), 10091-10096 (2007).

C. R. Doerr, L. Chen, M. S. Rasras, Y.-K. Chen, J. S. Weiner, and M. P. Earnshaw, “Diplexer With Integrated Filters and Photodetector in Ge-Si Using T-X and I-M Directions in a Grating Coupler,” IEEE Photonics Technology Letters 21 (22), 1698-1700 (2009).

L. Xu, Q. Li, N. Ophir, K. Padmaraju, L.-W. Luo, L. Chen, M. Lipson, and K. Bergman, “Colorless Optical Network Unit Based on Silicon Photonic Components for WDM PON,” IEEE Photonics Technology Letters 24 (16), 1372-1374 (2012).

J. Chen, L. Liu, and Y. Shi, “A Polarization-Insensitive Dual-Wavelength Multiplexer Based on Bent Directional Couplers,” IEEE Photonics Technology Letters 29 (22), 1975-1978 (2017).

J. Chen and Y. Shi, “An Ultracompact Silicon Triplexer Based on Cascaded Bent Directional Couplers,” Journal of Lightwave Technology 35 (23), 5260-5264 (2017).

H. Xu and Y. Shi, “On-Chip Silicon Triplexer Based on Asymmetrical Directional Couplers,” IEEE Photonics Technology Letters 29 (15), 1265-1268 (2017).

Y. Shi, S. Anand, and S. He, “Design of a Polarization Insensitive Triplexer Using Directional Couplers Based on Submicron Silicon Rib Waveguides,” Journal of Lightwave Technology 27 (11), 1443-1447 (2009).

J. Xiao, X. Liu, and X. Sun, “Design of an ultracompact MMI wavelength demultiplexer in slot waveguide structures,” Opt. Express, OE 15 (13), 8300-8308 (2007).

Y. Shi, S. Anand, and S. He, “A Polarization-Insensitive 1310/1550-nm Demultiplexer Based on Sandwiched Multimode Interference Waveguides,” IEEE Photonics Technology Letters 19 (22), 1789-1791 (2007).

L. Liu, Q. Deng, and Z. Zhou, “An Ultra-Compact Wavelength Diplexer Engineered by Subwavelength Grating,” IEEE Photonics Technology Letters 29 (22), 1927-1930 (2017).

L. Xu, Y. Wang, D. Mao, E. El-Fiky, Z. Xing, A. Kumar, M. G. Saber, M. Jacques, and D. V. Plant, “Broadband 1310/1550 nm wavelength demultiplexer based on a multimode interference coupler with tapered internal photonic crystal for the silicon-on-insulator platform,” Opt. Lett., OL 44 (7), 1770-1773 (2019).

H. Yi, Y. Huang, X. Wang, and Z. Zhou, “Ultra-short silicon MMI duplexer,” in Nanophotonics and Micro/Nano Optics (SPIE, 2012), 8564, pp. 175-180.

L. B. Soldano and E. C. M. Pennings, “Optical multi-mode interference devices based on self-imaging: principles and applications,” Journal of Lightwave Technology 13 (4), 615-627 (1995).

A. Y. Piggott, J. Lu, K. G. Lagoudakis, J. Petykiewicz, T. M. Babinec, and J. Vučković, “Inverse design and demonstration of a compact and broadband on-chip wavelength demultiplexer,” Nature Photon 9 (6), 374-377 (2015).

Y. Ma, P. Magill, T. Baehr-Jones, and M. Hochberg, “Design and optimization of a novel silicon-on-insulator wavelength diplexer,” Opt. Express, OE 22 (18), 21521-21528 (2014).

Z. Mohammed, B. Paredes, J. Villegas, and M. Rasras, “An Ultra-Compact CMOS Compatible MMI based 1310/1550 nm Wavelength (de) Multiplexer,” in 2021 European Conference on Optical Communication (ECOC) (2021), pp. 1-3

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. An optical polarizer, comprising:
a substrate;
an input waveguide positioned on the substrate having an input end and an output end, and a channel running from the input end to the output end;
a tapered multimode waveguide positioned on the substrate having at least one side substantially parallel to at least a portion of the channel and positioned at a distance from the at least a portion of the channel, having an input end and an output end;
a terminator positioned on the substrate connected to the output end of the tapered multimode waveguide; and
an s-bend positioned on the substrate along the channel of the input waveguide.

2. The polarizer of claim 1, further comprising a bend positioned on the substrate connecting the output of the tapered multimode waveguide to the terminator.

3. The polarizer of claim 2, wherein the bend is a 180-degree bend.

4. The polarizer of claim 1, wherein the multimode waveguide is tapered and proximate to a single mode waveguide with a uniform gap forming an asymmetrical directional coupler (ADC).

5. The polarizer of claim 1, wherein the design is complementary metal-oxide semiconductor (CMOS) compatible.

6. The polarizer of claim 1, wherein the substrate comprises SiO2 and the input waveguide and tapered multimode waveguide comprise silicon (Si) or silicon nitride (SiN).

7. The polarizer of claim 1, wherein the terminator is tapered with its ending width tending to zero.

8. An optical demultiplexer, comprising:
a substrate;
an input channel positioned on the substrate having an input end and an output end, defining a primary axis running from the input end to the output end, the input channel configured to receive at least two multiplexed optical signals having different wavelengths;
a multimode interface (MMI) coupler positioned on the substrate and connected to the output end of the input channel, the MMI coupler having a length running parallel to the primary axis and a width perpendicular to the primary axis; and
at least two output channels positioned on the substrate at the opposite end of the MMI coupler from the input channel, each configured to receive one of the at least two multiplexed optical signals;
wherein the length of the MMI coupler is about equal to a first beat length of one of the wavelengths of the at least two multiplexed optical signals.

9. The optical demultiplexer of claim 8, wherein one of the output channels terminates in a bar-port and the other output channel terminates in a cross-port, and wherein the bar and cross port widths are asymmetric.

10. The optical demultiplexer of claim 8, wherein at least one of the at least two output channels comprises an S-bend.

11. The optical demultiplexer of claim 8, wherein the input channel comprises a tapered portion, wherein the starting width of the taper is narrower, and the ending width is wider connecting the MMI coupler.

12. The optical demultiplexer of claim 8, wherein at least one of the at least two output channels comprises a tapered portion, wherein the output tapers have asymmetric starting widths, and symmetric end widths connecting S-bends.

13. The optical demultiplexer of claim 8, wherein the MMI coupler is substantially rectangular.

14. The optical demultiplexer of claim 8, wherein the optical demultiplexer is fully CMOS compatible.

15. The optical demultiplexer of claim 8, wherein the substrate comprises SiO₂ and the input channel, MMI coupler, and output channels comprise silicon (Si) or silicon nitride (SiN).

16. The optical demultiplexer of claim 8, wherein one wavelength of the wavelengths of the at least two multiplexed optical signals is 1550 nm.

17. The optical demultiplexer of claim 16, wherein the length of the MMI coupler is about 41 μm.
